(19) United States
(12) Patent Application Publication
(10) Pub. No.: US 2006/0064949 A1
(43) Pub. Date: Mar. 30, 2006

(54) Horse blankets and methods of making

(75) Inventor: Chia-Wei Chang, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eastwest International (Taiwan) Enterprises, Taichung (TW)

(21) Appl. No.: 10/949,727

(22) Filed: Sep. 24, 2004

(51) Int. Cl. B68C 5/00

(52) U.S. Cl. 54/79.2

(57) ABSTRACT

Horse blankets and methods of making blankets are provided which result in improved fit, greater comfort, improved coverage on the horse, and/or a more secure fit when in use. One such blanket (100) includes a body of blanket material having right and left side portions (110). The right and left side portions are adapted to extend down the horse's right and left sides, respectively, when the body of blanket material lies on the horse's back. The tight and left side portions further include a curved back edge (124) adapted to reduce a length of a bottom edge (130) of the right and left side portions. The curved back edge helps allow for increased movement of the horse's back legs without the horse's legs rubbing on and/or being restrained by the blanket.

### BACKGROUND OF THE INVENTION

The present invention relates generally to horse blankets, and more specifically, to horse blankets and methods of making blankets which provide improved fit and comfort.

Horse blankets are commonly used to keep horses warm when they are not being ridden or worked. Blankets may range from a thin summer sheet similar to a T-shirt, to a thicker winter blanket. Blankets for outdoor use may be waterproof, while blankets used only in stables or indoors may not be waterproof. Typical blankets are nearly uniform in shape and generally hang straight down the sides of the horse. Blankets may or may not have attachment devices to keep the blanket on the horse should the horse be outside on a breezy day, or begin to trot, gallop, or the like. Some blankets have a front edge which abuts or partially covers the withers of the horse. If blankets fit too closely, the neckline at the withers can chafe or rub hair from the horse, causing discomfort. The straight-hanging horse blankets also may restrict leg movement of the horse when walking, trotting, or the like. Improvements are desired in fit and comfort.

### BRIEF SUMMARY OF THE INVENTION

The present invention relates generally to horse blankets, and more specifically, to horse blankets and methods of making blankets. Horse blankets of the present invention are designed to provide improved fit, greater comfort, improved coverage on the horse, and/or to provide for a more secure fit when in use on the horse.

In one embodiment of the present invention, a horse blanket includes a body of blanket material having right and left side portions. The right and left side portions are adapted to extend down the horse's right and left sides, respectively, when the body of blanket material lies on the horse's back. The right and left side portions further include a curved back edge adapted to reduce a length of a bottom edge of the right and left side portions. The curved back edge helps allow for increased movement of the horse's back legs without the horse's legs rubbing on and/or being restrained by the blanket.

In some aspects, the length of the bottom edges of the right and left side portions is less than the length of the centerline of the blanket, with the centerline extending along the horse's back. In this manner, the bottom edges of the blanket hanging to the sides of the horse are less likely to restrict movement of the horse's legs when the horse is in the field or otherwise moving about. In some aspects the curved back edges of the right and left side portions each include an undercut edge adapted to be adjacent to the horse's right and left thighs. In other aspects, the curved back edges each include a rearward extension that transitions into the undercut edge. The rearward extension may be used, for example, to provide further blanket coverage over the horse's hips and buttocks. In some aspects, the right and left side portions each further include a curved front edge adapted to reduce the right and left side portion sizes adjacent the horse's right and left forearms. In this manner, the curved front edge helps facilitate movement of the horse's front legs or forearms.

In some aspects the horse blanket includes a coupler adapted to extend from the right side portion over the bottom edges to the left side portion. In other embodiments, the coupler is adapted to extend from the left side portion over the bottom edges to the right side portion. The coupler may comprise a surcingle, a buckle, a clip, or the like. The blanket may further include a coupler adapted to couple a front edge of the right side portion with a front edge of the left side portion. In this manner, the blanket is retained about the horse's chest. The front coupler may comprise a surcingle, a buckle, a clip, or the like.

In some aspects, the blanket further includes a shoulder portion defining a neckline, with the shoulder portion having a dart formed therein. The dart may include a cutout along the neckline to help the blanket lay flat on the horse's shoulders. In one embodiment, the dart is a generally triangular-shaped folded portion of the neckline, with the dart adapted to encourage the shoulder portion to lay flat on the horse's shoulders. In some aspects, the right and left side portions each include a dart at the neckline.

The blanket may further include a raised withers portion coupled to the right and left side portions. The raised withers portion is adapted to join a neckline of the right and left side portions. In one aspect, the withers portion includes a generally triangular-shaped segment of blanket material coupled to the right and left side portions, although other shapes may be used. The withers portion is adapted to lie generally flush with the horse's withers when the blanket is draped over the horse's back. In this manner, the raised withers portion lays over the horse's withers, but is not biased against the horse's withers which would cause unnecessary chafing, rubbing or irritation to the horse's neck or withers.

In another embodiment of the present invention, a horse blanket includes a sheet of material having front and back edges and first and second side edges. The front and back edges are generally symmetric relative to a centerline of the material, with the centerline adapted to extend down a horse's back when the blanket is placed thereon. The back edge includes an undercut portion adjacent the first and second side edges. Similarly, the front edge may include an undercut portion adjacent the first and second side edges. In this manner, the first and second side edges may have a length that is less than a centerline length. The horse blanket may further comprise first and second darts in the front edge, with the darts positioned generally symmetric relative to the centerline. Further, in one aspect the back edge has two different radii of curvature extending from the centerline to each of the first and second side edges. In one embodiment, the back edge curves outward to cover the buttocks portion of the horse, and then curves inward, in an undercut fashion to allow greater freedom of movement for the horse's rear legs. The blanket may include one or more belly bands having a coupler, with the coupler comprising a wide range of couplers, including a surcingle set in one embodiment.

The present invention further provides methods of making horse blankets. In one embodiment, the method includes providing a body of blanket material, with the body being substantially symmetric about a centerline. The body of blanket material has right and left portions that extend from the centerline. The method includes defining front and rear undercut edges in one or both of the right and left portions of the blanket material. The undercut edges reduce a length of a bottom edge of the right and/or left portions compared to a length of the centerline. In some aspects the method includes creating a dart in a neckline by a folding over of the blanket material at the dart location. In other aspects, the method includes creating a raised neckline by removing a portion of the right and left portions extending from a front edge to the centerline. The removed portion is substantially symmetric relative to the centerline. The method then includes attaching a blanket material insert that has a greater surface area than the removed portion. In this manner, greater room is provided for the horse at the horse's withers.

Other objects, features, and advantages of the present invention will become more fully apparent from the following description, the appended claims, and the accompanying drawings.

### BRIEF DESCRIPTION OF THE DRAWINGS

FIG. 1 is a simplified side view of a blanket according to an embodiment of the present invention;

FIG. 2 is a simplified side view of the blanket of FIG. 1 transposed on a prior art blanket;

FIG. 3 depicts the blanket of FIG. 1 on a horse;

FIG. 4 is an overall view of a portion of a coupler for use with blankets of the present invention; and

FIG. 5A-5E are various views of a surcingle set coupler for use with embodiments of the present invention.

### DETAILED DESCRIPTION OF THE INVENTION

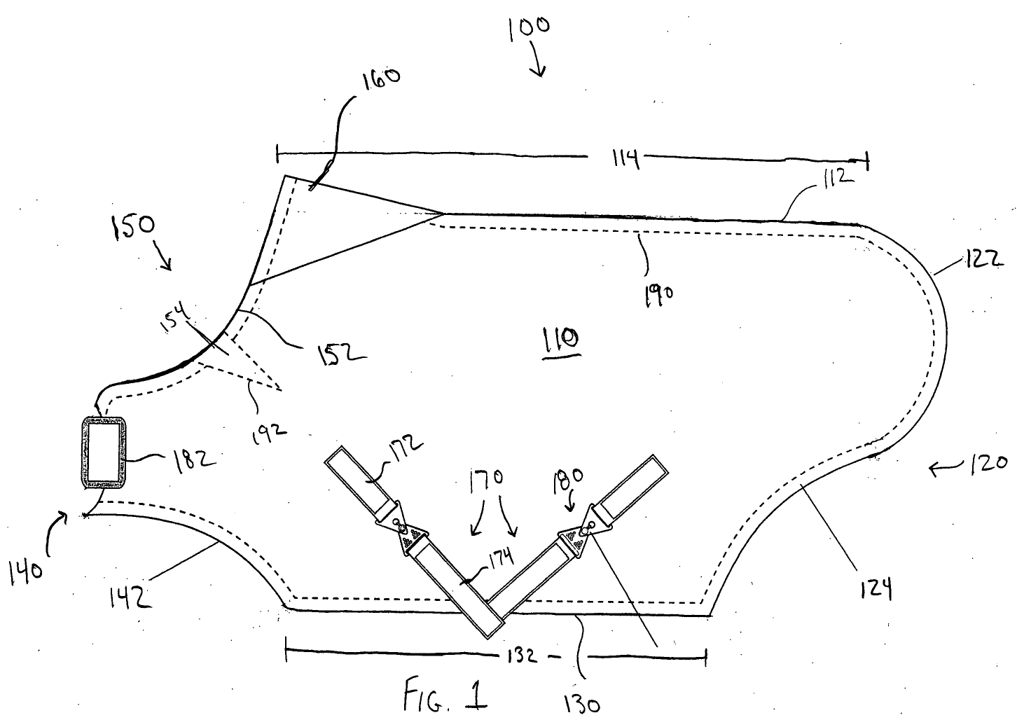

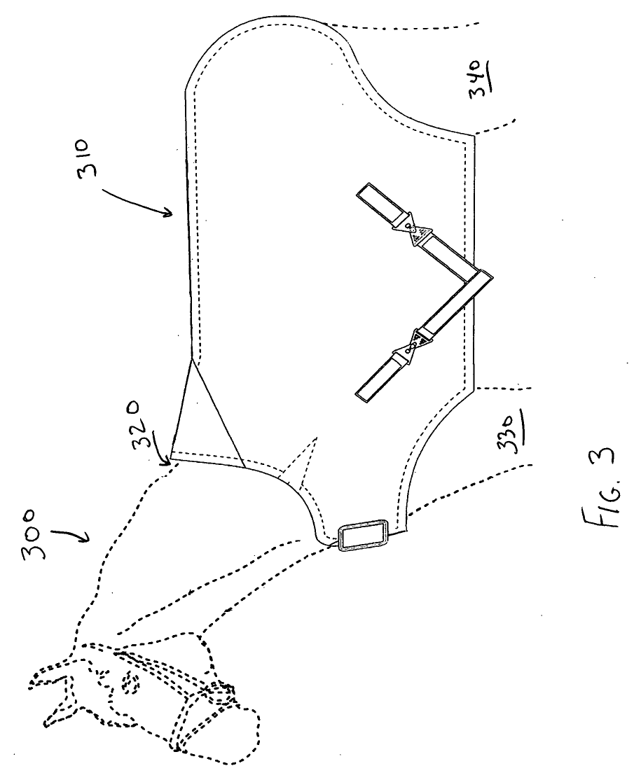

With reference to FIGS. 1-3, an embodiment of a horse blanket 100 according to the present invention will be described. While this embodiment is described having multiple features, alternative embodiments of the present invention may have one or more of these features individually, or in combination. With respect to FIG. 1, horse blanket 100 has right and left side portions 110. Only left side portion 110 is depicted in FIG. 1. In a preferred embodiment, horse blanket 100 is generally symmetrical in shape about a centerline 112. In this embodiment, the right side portion of blanket 100 will have at least some of the features depicted in left side portion 110. Blanket 100 has a back or rear edge 110 that transitions from centerline 112 to a bottom edge 130. It will be appreciated by those skilled in the art that the use of front, back, top, and bottom are intended to describe the configuration of blanket 100 when draped over a horse 300 as shown in FIG. 3. When blanket 100 is not on a horse, the front, back, left, and right nomenclature may be reversed or altered.

In one embodiment, back edge 120 has an extension 122 that extends outward from centerline 112 in the manner depicted in FIG. 1. Extension 122 is adapted to provide greater coverage on a horse's rump or buttocks. Back edge 120 may further include an undercut edge 124 that transitions to bottom edge 130. As best seen in FIG. 3, undercut edge 124 is adapted to lie generally adjacent a thigh portion of the horse's back leg 340. In this manner, the horse's back leg 340 can take longer strides before engaging the blanket's undercut edge 124. This provides increased comfort for the horse, and allows for increased range of motion compared to a straight hanging blanket. Blanket 100 further includes a front edge 140. In one embodiment, front edge 140 includes an undercut edge 142 that extends from front edge 140 to bottom edge 130. As can be seen in FIG. 3, front edge 142 lies generally adjacent a forearm or front leg 330 of horse 300. In this manner, undercut edge 142 helps facilitate foreleg movement of horse 300 for greater comfort.

In one embodiment, undercut edges 124 and/or 142 result in bottom edge 330 having a length 132 that is shorter than a length 114 of centerline 112. This configuration again allows for freer movement of the horse's legs. As shown in FIG. 1, blanket 100 has a shoulder portion 150 that includes a neckline 152. The neckline 152 may extend from front edge 140 to centerline 112, along one or both side portions 110. In one embodiment, neckline 152 incorporates a raised withers portion 160. In one embodiment, withers portion 160 comprises a generally triangular piece of blanket material that extends from approximately centerline 112 to shoulder portion 150. As shown, in one embodiment withers portion 160 further defines at least a part of neckline 152. In this manner, raised withers portion 160 provides greater comfort and room at the horse's withers. This configuration helps avoid the rubbing of hair on horse 300, which otherwise may be rubbed and fall off when using prior art blankets.

In one embodiment, neckline 152 has a dart 154 formed therein. Dart 154 is formed in the neckline portion of left side portion 110. Dart 154 also may be formed in the neckline of right side portion 110. In one embodiment, dart 154 is a cutout or removed piece of shoulder portion 150. In this embodiment, dart 154 helps shoulder portion 150 lie flatter against the horse's shoulders. In another embodiment, dart 154 comprises a folded over portion of the material used to make blanket 150. The folded over material is then stitched, glued, or otherwise attached to adjoining material in shoulder portion 150. In a particular embodiment, a stitching 192 is used to form dart 154, as generally shown by the dashed line in FIG. 1. In this manner, dart 154 provides an increased thickness of blanket 100 at the dart location. In some embodiments, additional stitching is used about the general periphery of blanket 100 as shown by dotted line 190. In one embodiment, adding darts 154 to the neckline helps shorten the neckline. In this manner, the front edges of the right and left side portions 110 are raised. Further, a front edge coupler 182 may be raised. This effect is particularly noticeable when darts 154 are formed by folding over a portion of the material used to make blanket 150. As a result, blanket 100 has more room in the chest for the horse.

To help maintain blanket 100 on horse 300, blanket 100 may further include one or more couplers 170. In one embodiment, coupler 170 includes one or more belly bands. As shown in FIG. 1, in one embodiment a portion of first band 172 is stitched or otherwise attached to left side portion 110 of blanket 100. First band 172 couples to a second band 174. Second band 174 has an end or other segment that is coupled to the right side portion of blanket 100 (not seen in FIG. 1). Second band 174 then extends underneath the horse, crossing over bottom edges 130 of both the left and right side portions of blanket 100. A coupling mechanism 180 then operates to couple bands 172 and 174 together to help maintain blanket 100 on horse 300. As shown in FIG. 1, in one embodiment two crossing second bands 174 are used to help affix blanket 100 to horse 300. In one embodiment, bands 172 and 174 are coupled together on the left side portion of blanket 100 when blanket 100 is on horse 300. In other embodiments, first band 172 passes under the horse and couples to band 174 on the right side portion of blanket 100. Other band arrangements or combinations may be used within the scope of the present invention. For example, a single band may be used. Alternatively, two bands are used that do not cross as depicted in FIG. 1. Other coupling mechanisms also fall within the scope of the present invention.

In some embodiments, blanket 100 further includes front edge coupler 182 as schematically depicted in FIG. 1. Front edge coupler 182 may include a coupling mechanism similar to coupler 170. Coupler 182 may comprise, for example, a belt, surcingle, clip, latch, or the like. In one embodiment, front edge coupler 182 operates to couple front edge 140 of the right side portion to front edge 140 of left side portion 110.

Blanket 100 may be made from one or more sheets or pieces of waterproof blanket material, or non-waterproof material. In some embodiments, blanket 100 is a multi-layered blanket for use in colder climates or seasons. Alternatively, blanket 100 is a thinner material for use in warmer climates or warmer seasons.

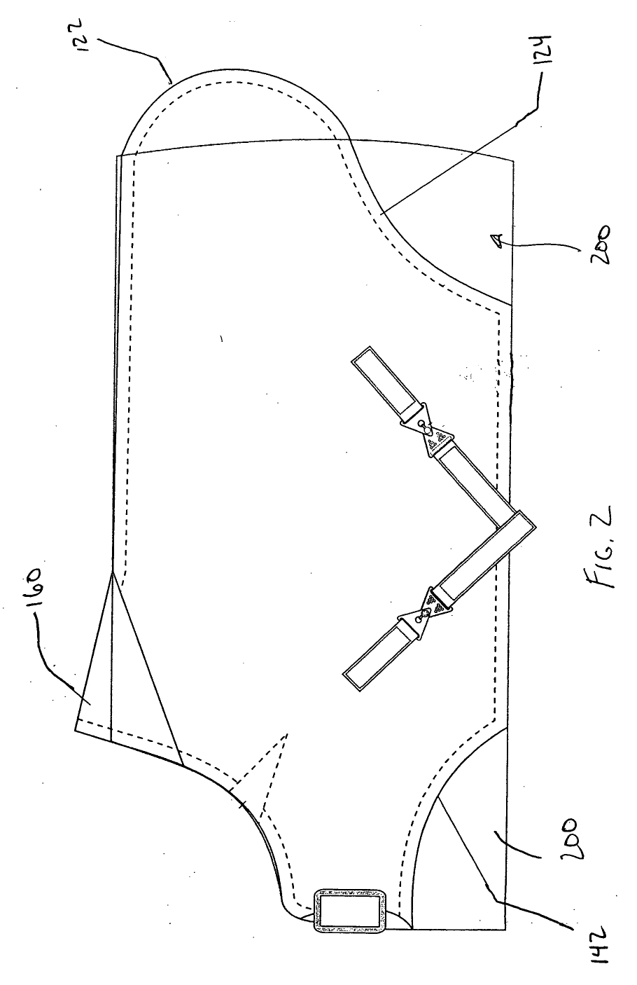

With reference to FIG. 2, blanket 100 is shown disposed over a prior-art blanket 200. Undercut edges 124 and 142 provide increased leg room for a horse wearing blanket 100 compared to blanket 200. In some embodiments, back edge 122 provides increased coverage over the horse's rump or buttocks. Further, withers portion 160 increases the comfort of blanket 100 when on the horse. In some embodiments, withers portion 160 provides increased room for the horse at the horse's withers or base of the neck.

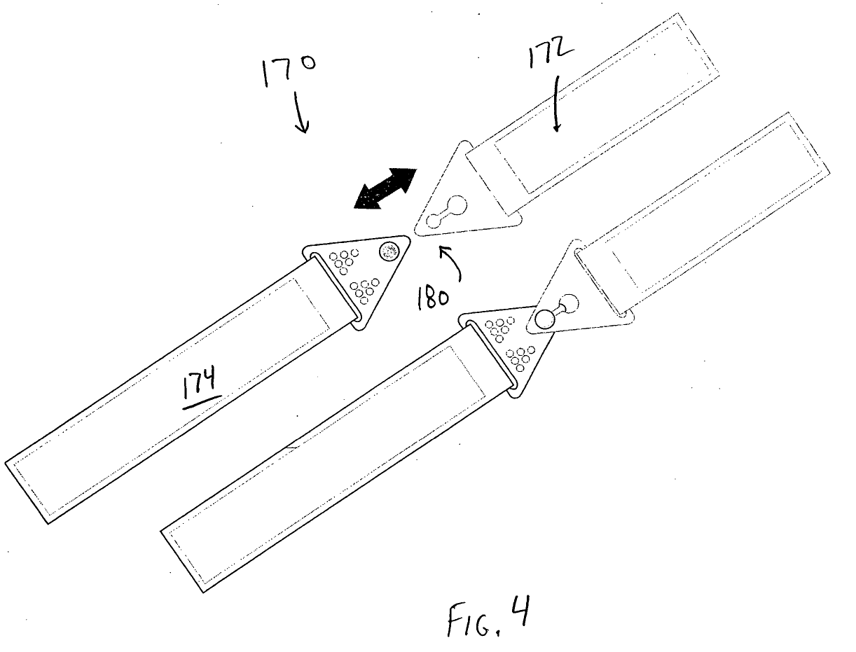

As can be seen in FIG. 4, in one embodiment coupler 170 comprises first and second bands 172 and 174 having coupling mechanisms affixed thereto. Coupling mechanisms 180 are adapted to couple together, to help hold together bands 172 and 174. In one embodiment, band 174 passes under the horse's belly and couples to left side portion 110 (as seen in FIG. 3). Alternatively, coupling mechanisms 180 are disposed on the right side portion of blanket 100. It may be desirable, in some embodiments, to have coupling mechanism 180 disposed on the left or right side of the horse as opposed to directly under the horse. This facilitates ease of use of coupling mechanism 180, and also provides a blanket layer between coupling mechanism 180 and the horse.

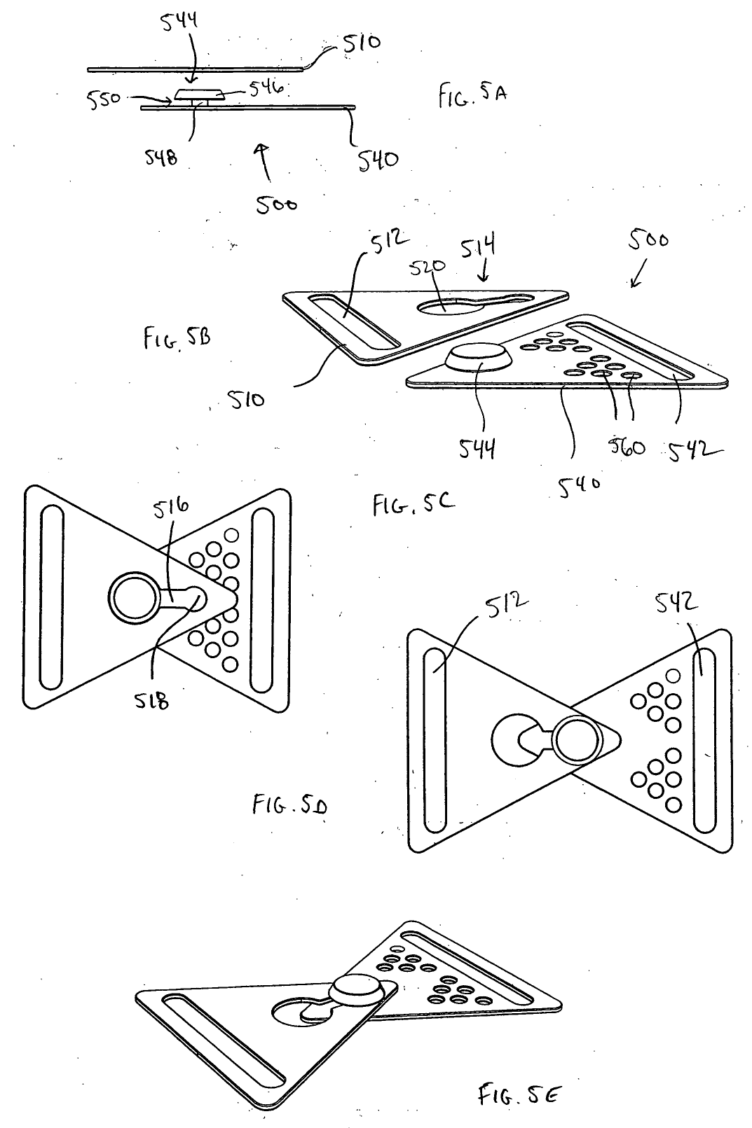

As depicted in FIGS. 4 and 5A-5E, in one embodiment coupling mechanism 180 comprises a surcingle set 500. Surcingle set 500 may be similar or identical to coupling mechanism 180 used for blanket 100. As shown in FIG. 5A, surcingle set 500 includes a female piece 510 and a male piece 540. Female piece 510 includes a slot 512 passing therethrough for attaching female piece 510 to a strap, band, or the like as shown in FIG. 4. Male portion 540 also includes a slot 542 for coupling male portion 540 to a strap or belt similar to bands 172, 174. Female piece 510 includes a coupling hole 514. In one embodiment, coupling hole 514 has a larger hole 520 and a smaller hole 518 connected together by a channel 516.

Coupling hole 514 is adapted to receive an extension 544 that extends from a surface of male piece 540. Extension 544 may comprise a mushroom-shaped extension having a cap portion 546 supported by a stem 548. Cap 546 has a larger width or diameter than does stem 548 to define a gap 550 between cap 546 and the surface of male piece 540 from which extension 544 extends. Gap 550 facilitates coupling of female and male pieces 510, 540. Extension 544 may have additional shapes other than that depicted in FIGS. 5A-5E.

As can be seen in FIG. 5C, extension member 544 fits into and through larger hole 520. In this embodiment, the width or diameter of cap 546 is less than the width or diameter of larger hole 520. One or both of male and female pieces 540, 510 are translated to slidably engage the two pieces. More specifically, female piece 510 slides under cap 546 into gap 550 as stem 548 slides along channel 516 and into smaller hole 518. Once stem 548 is in smaller hole 518, male piece 540 and female piece 510 are coupled together since the width or diameter of cap 546 is greater than the width or diameter of smaller hole 518. Male and female pieces 540, 510 may be decoupled by sliding stem 548 back through channel 518 into larger opening 520, and removing extension member 544 through larger hole 520. In some embodiments, stem 548 fits snugly into channel 516 so that stem 548 cannot easily slip from smaller hole 518 into larger hole 520. The use of surcingle set 500 with bands 172, 174 allows bands 172 and 174 to be easily coupled together. In particular, surcingle set 500 can be coupled together without having to twist or rotate either female piece 510 or male piece 540. In some embodiments, to engage coupling of male and female pieces 540, 510, stem 548 is positioned at a desired angle relative to coupling hole 514. The angle, in one embodiment, is between about seventy degrees (70°) and about ninety degrees (90°). In this embodiment, male and female pieces 540, 510 are generally co-planar when surcingle set 500 is coupled, providing for ease of coupling.

Male portion 540 may further include one or more holes 560 in one embodiment. Holes 560 may be configured in any desired pattern and/or shape as decorative features. Holes 560 also may nominally reduce surcingle weight without negatively effecting the function of the surcingle.

Further details on surcingle sets for use with the present invention are described in U.S. patent application Ser. No. ______, entitled “Surcingle Sets and Methods of Making,” filed contemporaneously herewith and assigned to the assignee of the present invention, the complete disclosure of which is incorporated herein by reference.

The invention has now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific example, but rather to be accorded the scope represented in the following claims.

What is claimed is:

1. A horse blanket, comprising:
a body of blanket material having right and left side portions adapted to lie along a horse's back and extend down the horse's right and left sides, respectively;
wherein the right and left side portions each have a curved back edge adapted to reduce a length of a bottom edge of the right and left side portions.

2. The horse blanket as in claim 1 wherein the length of the bottom edge is less than a length of a centerline of the blanket material adapted to extend along the horse's back.

3. The horse blanket as in claim 1 wherein the curved back edges of the right and left side portions each include an undercut edge adapted to be adjacent the horse's right and left thighs.

4. The horse blanket as in claim 3 wherein the right and left side curved back edges each include a rearward extension which transitions into the undercut edge.

5. The horse blanket as in claim 1 wherein the right and left side portions each include a curved front edge adapted to reduce the right and left side portions adjacent the horse's right and left forearms, respectively.

6. The horse blanket as in claim 1 further comprising a coupler adapted to extend from one of the right and left side portions, over the bottom edges, to the other of the right and left side portions.

7. The horse blanket as in claim 6 wherein the coupler comprises a surcingle.

8. The horse blanket as in claim 1 further comprising a coupler adapted to couple a front edge of the right side portion with a front edge of the left side portion.

9. The horse blanket as in claim 8 wherein the coupler comprises a surcingle.

10. The horse blanket as in claim 1 wherein the right and left side portions each further comprise a shoulder portion defining a neckline, the shoulder portion having a dart formed therein.

11. The horse blanket as in claim 10 wherein the dart comprises a generally triangular shaped folded portion of the neckline, the dart adapted to encourage the shoulder portion to lay flat on the horse's shoulder.

12. The horse blanket as in claim 1 further comprises a raised withers portion coupled to the right and left side portions and adapted to join a neckline of the right and left side portions.

13. The horse blanket as in claim 12 wherein the withers portion comprises a generally triangular shaped segment of blanket material coupled to the right and left side portions.

14. The horse blanket as in claim 12 wherein the withers portion is adapted to lie generally flush with the horse's withers when the blanket is draped over the horse's back.

15. A horse blanket, comprising:
a sheet of material having a front edge, a back edge, and first and second side edges;
wherein the front and back edges are generally symmetric relative to a centerline, the centerline adapted to extend down a horse's back when the blanket is placed thereon; and
wherein the back edge includes an undercut portion adjacent the first and second side edges.

16. The horse blanket as in claim 15 wherein the front edge includes an undercut portion adjacent the first and second side edges, and wherein the first and second side edges each have a length that is less than a centerline length.

17. The horse blanket as in claim 15 wherein the front edge further defines a neckline, the neckline including a raised withers portion.

18. The horse blanket as in claim 15 wherein the front edge further comprises first and second darts positioned generally symmetric relative to the centerline.

19. The horse blanket as in claim 18 wherein the first and second darts each comprise a folded portion of the sheet of material.

20. The horse blanket as in claim 15 wherein the back edge has two different radii of curvature extending from the centerline to each of the first and second side edges.

21. The horse blanket as in claim 15 further comprising a belly band set having a coupler.

22. The horse blanket as in claim 21 wherein the coupler comprises a surcingle.

23. A method of making a horse blanket, the method comprising:
providing a body of blanket material, the body being substantially symmetric about a centerline, and comprising right and left portions extending from the centerline;
defining a front undercut edge and a rear undercut edge in each of the right and left portions of the blanket material;
wherein the front and rear undercut edges on each of the right and left portions reduces a length of a bottom edge of the right and left portions, respectively, compared to a length of the centerline.

24. The method as in claim 23 further comprising creating a dart in a neckline of each of the right and left portions, the dart comprising a folding over of the blanket material at the dart location.

25. The method as in claim 23 further comprising creating a raised neckline by:
removing a portion of the right and left portions extending from a front edge of the right and left portions to the centerline, the removed portion being substantially symmetrical relative to the centerline; and
attaching a blanket material insert, the insert having a greater surface area than the removed portion.
